(19) United States
(12) Patent Application Publication
(10) Pub. No.: US 2007/0131561 A1
(43) Pub. Date: Jun. 14, 2007

(54) Controlling removal rate uniformity of an electropolishing process in integrated circuit fabrication

(75) Inventors: Hui Wang, Fremont, CA (US); Felix Gutman, San Jose, CA (US); Himanshu J. Chokshi, Fremont, CA (US)

Correspondence Address: MORRISON & FOERSTER LLP, 425 MARKET STREET, SAN FRANCISCO, CA, 94105-2482, US

(73) Assignee: ACM Research, Inc., Fremont, CA (US)

(21) Appl. No.: 10/583,516

(22) PCT Filed: Dec. 17, 2004
(86) PCT No.: PCT/US04/42880

§ 371 Date: Jun. 16, 2006

Related U.S. Application Data
(60) Provisional application No. 60/530,385, filed on Dec. 17, 2003.
(60) Provisional application No. 60/587,637, filed on Jul. 13, 2004.

(51) Int. Cl. B23H 3/00

(52) U.S. Cl. 205/652

(57) ABSTRACT

An electropolishing process in integrated circuit fabrication on a wafer includes applying a stream of electrolyte to the wafer using a nozzle positioned adjacent to the wafer with a gap between the nozzle and the wafer. The removal rate uniformity of the electropolishing process is controlled by adjusting the gap between the nozzle and the wafer to adjust the removal rate profile of the stream of electrolyte applied by the nozzle.

### CROSS-REFERENCE TO RELATED APPLICATIONS

The present application claims the benefit of U.S. Provisional Application No. 60/530,385, filed Dec. 17, 2003, which is incorporated herein by reference in its entirety, and U.S. Provisional Application No. 60/587,637, filed Jul. 13, 2004, which is incorporated herein by reference in its entirety.

### BACKGROUND

1. Field

The present application generally relates to an electropolishing process used in integrated circuit (IC) fabrication, and, in particular, to controlling removal rate uniformity during an electropolishing process of a metal layer formed on a wafer used in IC fabrication.

2. Related Art

IC devices are manufactured or fabricated on wafers using a number of different processing steps to create transistor and interconnection elements. To electrically connect transistor terminals associated with the wafer, conductive (e.g., metal) trenches, vias, and the like are formed in dielectric materials as part of IC devices. The trenches and vias couple electrical signals and power between transistors, internal circuits of the IC devices, and circuits external to the IC devices.

In forming the interconnection elements, the wafer may undergo, for example, masking, etching, and deposition processes to form the desired electronic circuitry of the IC devices. In particular, multiple masking and etching steps can be performed to form a pattern of recessed areas in a dielectric layer on a wafer that serve as trenches and vias for the interconnections. A deposition process may then be performed to deposit a metal layer over the wafer to deposit metal both in the trenches and vias and also on the non-recessed areas of the wafer. To isolate the interconnections, such as patterned trenches and vias, the metal deposited on the non-recessed areas of the wafer is removed.

The metal layer deposited on the non-recessed areas of the dielectric layer can be removed using an electropolishing process. In particular, a nozzle can be used to apply an electrolyte solution to electropolish the metal layer. As the feature size of the IC devices continues to decrease, however, the removal rate uniformity of the electropolishing process needs to be enhanced.

### SUMMARY

In one exemplary embodiment, an electropolishing process in integrated circuit fabrication on a wafer includes applying a stream of electrolyte to the wafer using a nozzle positioned adjacent to the wafer. The removal rate uniformity of the electropolishing process is controlled by adjusting a gap between the nozzle and the wafer to adjust the removal rate profile of the stream of electrolyte applied by the nozzle.

In another exemplary embodiment, the stream of electrolyte is applied to the wafer using a nozzle with a diffuser positioned within the nozzle. The position of the diffuser within the nozzle is adjusted to adjust the removal rate profile of the stream of electrolyte applied by the nozzle.

In another exemplary embodiment, the stream of electrolyte is applied to different radial locations on the wafer using the nozzle. A first electropolishing charge is applied to a first electrode disposed adjacent to the edge of the wafer. The first electrode applies the first electropolishing charge to the wafer. A second electropolishing charge is applied to a second electrode disposed adjacent to the first electrode. The second electrode applies the second electropolishing charge to electrolyte that comes in contact with the second electrode as the electrolyte flows from the stream of electrolyte toward the edge of the wafer. The second electrode is electrically isolated from the first electrode. The first electropolishing charge applied to the first electrode or the second electropolishing charge applied to the second electrode is adjusted based on the radial location of the stream of electrolyte on the wafer. When the stream of electrolyte is near the center of the wafer, the second electropolishing charge is greater than the first electropolishing charge.

### BRIEF DESCRIPTION OF THE DRAWINGS

FIGS. 1A-1F are block diagrams of exemplary electropolishing tools;

FIG. 2 depicts an exemplary nozzle adjacent to a wafer during an electropolishing process;

FIG. 3A depicts an exemplary nozzle adjacent to a wafer during an electropolishing process;

FIGS. 3B, 3C, and 3D depict exemplary removal rate profiles of the exemplary nozzle depicted in FIG. 3A;

FIGS. 4A, 5A, and 6A depict an exemplary nozzle with an exemplary diffuser disposed within the nozzle;

FIGS. 4B, 5B, and 6B depict the exemplary diffuser depicted in FIGS. 4A, 5A, and 6A at different positions within the nozzle;

FIGS. 4C, 5C, and 6C depict exemplary removal rate profiles;

FIGS. 7A-7F depict various shapes for an exemplary diffuser;

FIGS. 8A and 8B depicts an exemplary nozzle with an exemplary diffuser used in an electropolishing process;

FIG. 9 depicts an exemplary control circuit used to control the removal rate uniformity of an electropolishing process;

FIGS. 10A and 10B depict exemplary removal rate profiles;

FIGS. 11-17 depict various exemplary control circuits used to control the removal rate uniformity of an electropolishing process;

FIG. 18 is a perspective view of an exemplary chuck assembly;

FIG. 19 is a perspective view of a portion of the exemplary chuck assembly depicted in FIG. 18;

FIG. 20 is an exploded view of the exemplary chuck assembly depicted in FIG. 18;

FIG. 21 is an exploded view of a portion of the exemplary chuck assembly depicted in FIG. 18;

FIG. 22 is a perspective view of a portion of the exemplary chuck assembly depicted in FIG. 21; and

FIG. 23 is a side, cut-away view of a portion of the exemplary chuck assembly depicted in FIG. 21.

### DETAILED DESCRIPTION

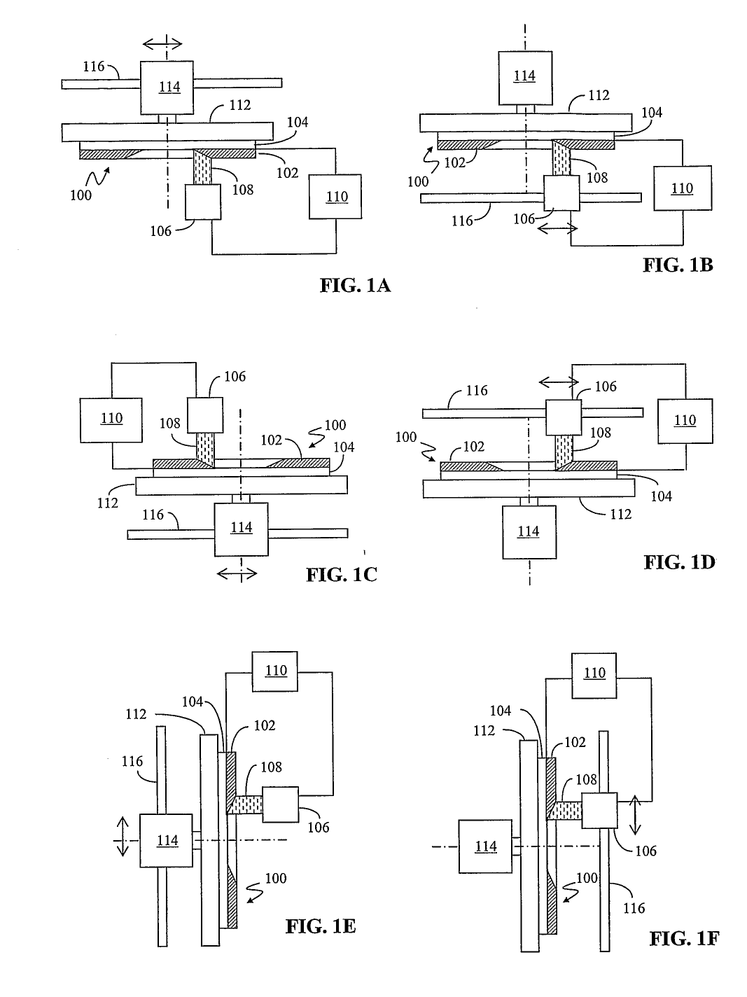

With reference to FIG. 1A, as part of an IC fabrication process, an exemplary electropolishing tool is configured to electropolish a metal layer 102 formed on a wafer 100. Metal layer 102 can include copper, which is increasingly being used to replace aluminum. It should be recognized, however, that metal layer 102 can include any electrically conductive material. Additionally, it should be recognized that the term “wafer” can be used to refer to substrate 104 on which subsequent layers are formed, or to refer collectively to substrate 104 and the subsequent layers formed on substrate 104.

In one exemplary embodiment, the electropolishing tool includes a nozzle 106 configured to apply a stream of electrolyte 108 to metal layer 102 at different radial locations on wafer 100. A power supply 110 is connected to nozzle 106 to apply a negative electropolishing charge to stream of electrolyte 108. Power supply 110 is also connected to wafer 100 to apply a positive electropolishing charge to wafer 100. Thus, during the electropolishing process, nozzle 106 acts as a cathode, and wafer 100 acts as an anode. When stream of electrolyte 108 is applied to metal layer 102, the difference in potential between electrolyte 108 and metal layer 102 results in the electropolishing of metal layer 102 from wafer 100. Although power supply 110 is depicted as being directly connected to wafer 100, it should be recognized that any number intervening connection can exist between power supply 110 and wafer 100. For example, power supply 110 can be connected to chuck 112, which is then connected to wafer 100, and, more particular to metal layer 102. For an additional description of electropolishing, see U.S. patent application Ser. No. 09/497,894, entitled METHOD AND APPARATUS FOR ELECTROPOLISHING METAL INTERCONNECTIONS ON SEMICONDUCTOR DEVICES, filed on Feb. 4, 2000, which is incorporated herein by reference in its entirety.

In the exemplary embodiment depicted in FIG. 1A, the electropolishing tool includes a chuck 112 that holds and positions wafer 100. The electropolishing tool also includes a motor 114 that rotates chuck 112, and thus wafer 100, during the electropolishing process. By rotating wafer 100, electrolyte 108 is applied in a spiral pattern on metal layer 102. In particular, in the present exemplary embodiment, chuck 112, and thus wafer 100, is translated along a guide rod 116 to translate wafer 100 in a lateral direction relative to nozzle 106 and stream of electrolyte 108. The relative motion between nozzle 106 and wafer 100 produced by rotating and translating wafer 100 results in electrolyte 108 being applied in a spiral pattern. It should be recognized, however that the relative motion between nozzle 106 and wafer 100 can achieved in various manners. For example, nozzle 106 and wafer 100 can be moved in a straight or curved trajectory in the lateral direction,

Although in the exemplary embodiment depicted in FIG. 1A wafer 100 is rotated and translated while nozzle 106 is kept stationary, it should be recognized that nozzle 106 and wafer 100 can be moved relative to each other in various manners using various mechanisms. For example, in the exemplary embodiment depicted in FIG. 1B, wafer 100 is only rotated, while nozzle 106 is translated. Although in the exemplary embodiment depicted in FIG. 1A nozzle 106 is disposed below wafer 100 to apply stream of electrolyte 108 vertically up to metal layer 102, it should be recognized that nozzle 106 and wafer 100 can be oriented in various manners. For example, in the exemplary embodiment depicted in FIG. 1C, nozzle 106 is disposed above wafer 100 to apply stream of electrolyte 108 vertically down to metal layer 102. In the exemplary embodiment depicted in FIG. 1C, chuck 112, and thus wafer 100, is rotated and translated, while nozzle 106 is kept stationary. In the exemplary embodiment depicted in FIG. 1D, nozzle 106 is translated, while chuck 112, and thus wafer 100, is rotated. In the exemplary embodiment depicted in FIG. 1E, nozzle 106 is disposed horizontally adjacent to wafer 100 to apply stream of electrolyte 108 horizontally to metal layer 102. In the exemplary embodiment depicted in FIG. 1E, chuck 112, and thus wafer 100, is rotated and translated, while nozzle 106 is kept stationary. In the exemplary embodiment depicted in FIG. 1F, nozzle 106 is translated, while chuck 112, and thus wafer 100, is rotated. It should be recognized that in the exemplary embodiments depicted in FIGS. 1A-1F, both nozzle 106 and chuck 112, and thus wafer 100, can be translated.

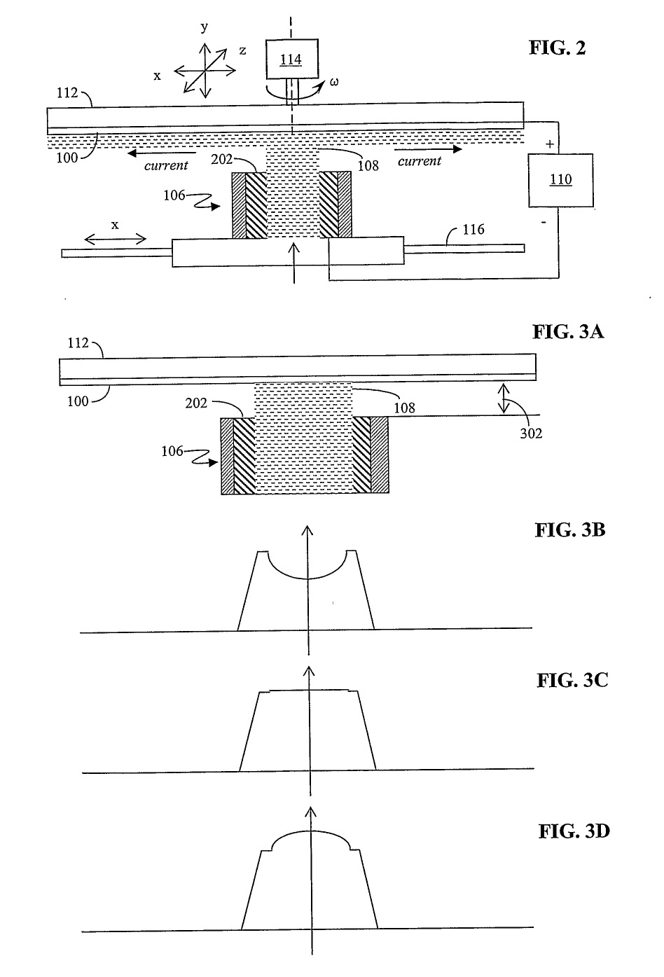

With reference to FIG. 2, in one exemplary embodiment, nozzle 106 includes an electrode 202 configured to apply a negative electropolishing charge to stream of electrolyte 108. In the present exemplary embodiment, the metal layer on wafer 100 makes contact with one or more electrode contacts located near the edge of wafer 100 (i.e., around the outer circumferential area of the surface on which the metal layer and IC structures are formed). In the present exemplary embodiment, before the electropolishing process begins, the metal layer is continuous from the center to near the edge, where the metal layer makes contact with the one or more electrode contacts. Thus, as depicted in FIG. 2, an electric current flows from stream of electrolyte 108 radially outward toward the edge of wafer 100. See, U.S. Pat. No. 6,188,222, entitled METHODS AND APPARATUS FOR HOLDING AND POSITIONING SEMICONDUCTOR WORKPIECES DURING ELECTROPOLISHING AND/OR ELECTROPLATING OF THE WORKPIECES, issued Jun. 19, 2001, which is incorporated herein by reference in its entirety.

With reference to FIG. 3A, in the present exemplary embodiment, during the electropolishing process, nozzle 106 is positioned adjacent to wafer 100 with a gap 302 between nozzle 106 and wafer 100. As noted above, the term “wafer” can be used to refer collectively to substrate 104 (FIG. 1A) and any subsequent layers formed on substrate 104 (FIG. 1A). Thus, gap 302 between nozzle 106 and wafer 100 can also be viewed as the gap between nozzle 106 and the metal layer, which is formed on substrate 104 (FIG. 1A), either directly or on any number of intermediate layers. For the sake of convenience and clarity, gap 302 will be referred to as being defined between nozzle 106 and wafer 100 rather than between nozzle 106 and the metal layer.

As depicted in FIGS. 3B, 3C, and 3D, the size of gap 302 (FIG. 3A) has been found to be related to the removal rate profile of nozzle 106 (FIG. 3A). In particular, with reference to FIG. 3A, when stream of electrolyte 108 is applied to an area on the metal layer (i.e., a contact area on metal layer 102), the removal rate profile of the metal layer within the contact area is related to the size of gap 302. Thus, the removal rate profile can be controlled by adjusting the size of gap 302 between nozzle 106 and wafer 100.

For example, as depicted in FIG. 3B, a small gap 302 (FIG. 3A) has been found to result in a relatively concave removal rate profile. In particular, with reference to FIG. 3A, portions of the contact area toward the center of stream of electrolyte 108 are electropolished at a lower removal rate than portions of the contact area toward the edges of stream of electrolyte 108. As depicted in FIG. 3C, a medium gap 302 (FIG. 3A) has been found to result in a relatively flat removal rate profile. In particular, all portions of the contact area have the same removal rate. As depicted in FIG. 3D, a large gap 302 (FIG. 3A) has been found to result in a relatively convex removal rate profile. In particular, with reference to FIG. 3A, portions of the contact area toward the center of stream of electrolyte 108 are electropolished at a higher removal rate than portions of the contact area toward the edges of stream of electrolyte 108.

In the present exemplary embodiment, gap 302 is considered small when gap 302 is smaller or much smaller than the diameter of nozzle 106, and, more particularly, the diameter of stream of electrolyte 108. Gap 302 is considered large when gap 302 is greater or much greater than the diameter of nozzle 106, and, more particular, the diameter of stream of electrolyte 108.

With reference again to FIG. 3A, in one exemplary embodiment, the removal rate profile of nozzle 106 can be adjusted dynamically by adjusting gap 302 during the electropolishing process. More specifically, gap 302 can be adjusted as stream of electrolyte 108 is applied to different radial locations on wafer 100 based on the radial location of stream of electrolyte 108 on wafer 100. In the present exemplary embodiment, gap 302 is greater when stream of electrolyte 108 is applied near the edge of wafer 100 than when stream of electrolyte 108 is applied near the center of wafer 100. Thus, when stream of electrolyte 108 is applied from the center of wafer 100 toward the edge of wafer 100, gap 302 is increased. When stream of electrolyte 108 is applied from the edge of wafer 100 toward the center of wafer 100, gap 302 is decreased.

It should be recognized that gap 302 can be adjusted using various relative movements between wafer 100 and nozzle 106. For example, wafer 100 can be moved up and down, while keeping nozzle 106 level. Wafer 100 can be kept level, while nozzle 106 is moved up and down. Both wafer 100 and nozzle 106 can be moved up and down.

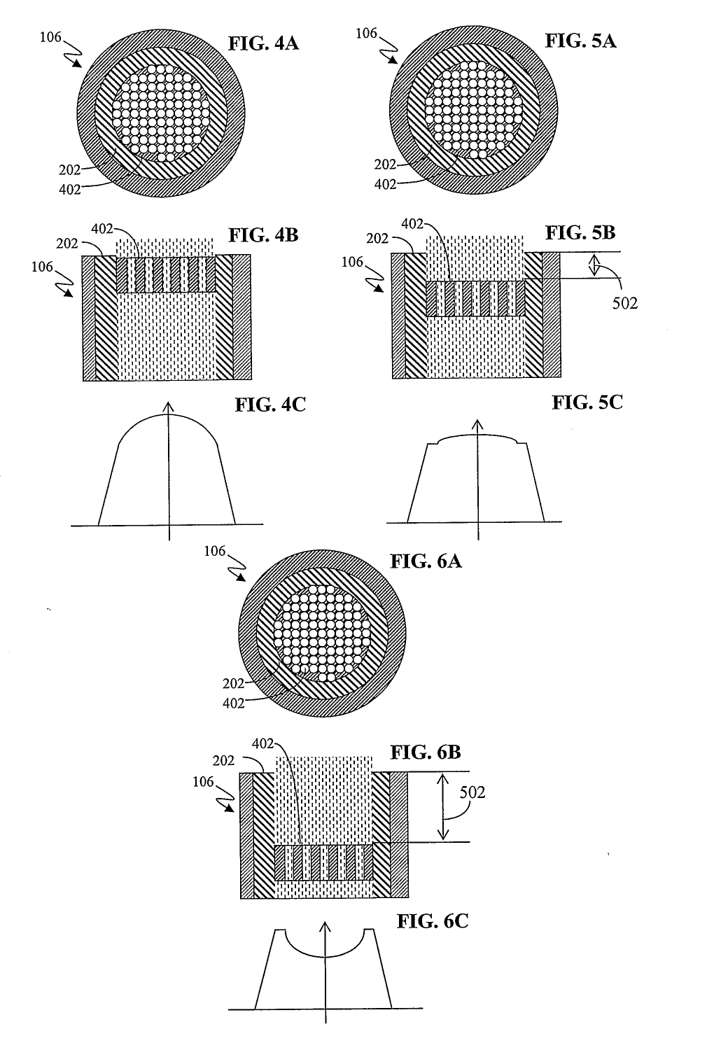

With reference to FIGS. 4A, 5A, and 6A, in one exemplary embodiment, nozzle 106 includes a diffuser (also referred to as a showerhead) 402. In the present exemplary embodiment, the position of diffuser 402 within nozzle 106 is adjusted to control the removal rate profile of nozzle 106.

In particular, as depicted in FIGS. 4B, 5B, and 6B, the position of diffuser 402 within nozzle 106 can be adjusted within a range of positions. As depicted in FIG. 4B, diffuser 402 can be set to a first position near the tip of nozzle 106, which is closer to the wafer. As depicted in FIG. 4C, by moving diffuser 402 closer to the wafer, a relatively convex removal rate profile can be achieved. As depicted in FIG. 5B, diffuser 402 can be set to a second position lower than the tip of nozzle 106, which is farther away from the wafer. In particular, diffuser 402 is a distance 502 from the tip of nozzle 106. Thus, the distance between diffuser 402 and the wafer is the sum of distance 502 and gap 302 (FIG. 3A). As depicted in FIG. 5C, by moving diffuser 402 farther away from the wafer, a flatter removal rate profile can be achieved. As depicted in FIG. 6B, diffuser 402 can be set to a third position much lower than the tip of nozzle 106, which is even farther away from the wafer than in the second position. As depicted in FIG. 6C, by moving diffuser 402 even farther away from the wafer, a concave removal rate profile can be achieved. Thus, by adjusting the position of diffuser 402 within nozzle 106, the removal rate profile of nozzle 106 can be adjusted.

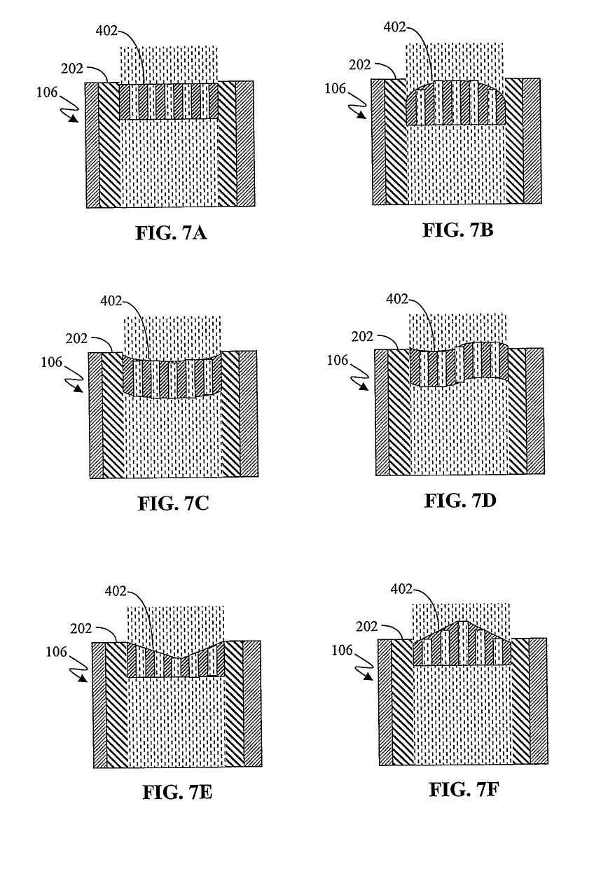

With reference to FIG. 7A, in one exemplary embodiment, the shape of diffuser 402 can be adjusted to control the removal rate profile of nozzle 106. The shape of diffuser 402 can affect the electropolishing current distribution across nozzle 106, which can affect the removal rate profile across nozzle 106.

For example, with reference to FIG. 7A, diffuser 402 having a flat shape can be used to achieve a relatively flat removal rate profile. With reference to FIG. 7B, diffuser 402 having a convex shape can be used to achieve a relatively convex removal rate profile. With reference to FIG. 7C, diffuser 402 having a concave shape can be used to achieve a relatively concave removal rate profile. With reference to FIG. 7D, diffuser 402 having an asymmetric shape can be used to achieve a relatively asymmetric removal rate profile. With reference to FIG. 7E, diffuser 402 having a concave triangular shape can be used to achieve a concave triangular removal rate profile. With reference to FIG. 7F, diffuser 402 having a convex triangular shape can be used to achieve a convex triangular removal rate profile.

It should be recognized that the tip of nozzle 106 can have the same or different shape as diffuser 402. For example, with reference to FIG. 7D, the tip of nozzle 106 can be symmetric or asymmetric. If the tip of nozzle 106 is asymmetric, when diffuser 402 is positioned at the tip of nozzle 106, the asymmetric shape of diffuser 402 can aligned with the asymmetric shape of the tip of nozzle 106.

Additionally, it should be recognized that the position and shape of the diffuser 402 can be used in conjunction to adjust the removal rate profile of nozzle 106. For example, with reference to FIG. 7C, while diffuser 402 having a concave shape tends to result in a concave removal rate profile, positioning diffuser 402 closer to the wafer will also tend to produce a convex removal rate profile. Thus, by positioning diffuser 402 having a concave shape closer to the wafer, a relatively flat removal rate profile can be achieved. It should be recognized that various combinations of shape and position of diffuser 402 within nozzle 106 can be used to achieve a desired removal rate profile.

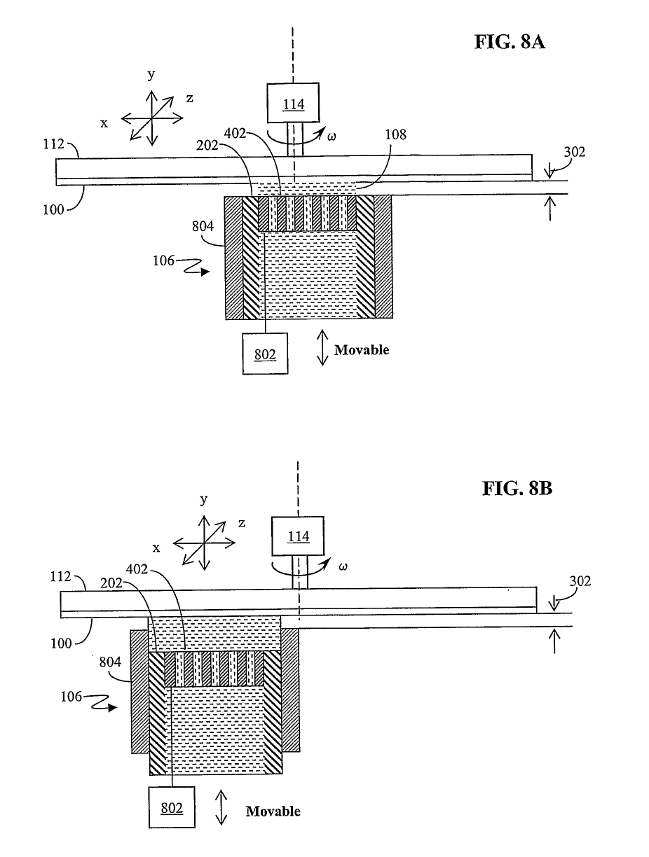

With reference to FIG. 8A, in one exemplary embodiment, the removal rate profile of nozzle 106 can be adjusted dynamically by adjusting the position of diffuser 402 during the electropolishing process. More specifically, the position of diffuser 402 can be adjusted as stream of electrolyte 108 is applied to different radial locations on wafer 100 based on the radial location of stream of electrolyte 108 on wafer 100. In the present exemplary embodiment, the position of diffuser 402 within nozzle 106 is lower when stream of electrolyte 108 is applied near the edge of wafer 100 than when stream of electrolyte 108 is applied near the center of wafer 100. Thus, when stream of electrolyte 108 is applied from the center of wafer 100 toward the edge of wafer 100, diffuser 402 is lowered within nozzle 106. When stream of electrolyte 108 is applied from the edge of wafer 100 toward the center of wafer 100, diffuser 402 is raised within nozzle 106.

As depicted in FIG. 8A, in the present exemplary embodiment, a drive mechanism 802 can be connected to diffuser 402 to adjust the position of diffuser 402 within nozzle 106. As depicted in FIG. 8A, when diffuser 402 has a flat shape and stream of electrolyte 108 is applied near the center of wafer 100, diffuser 402 is positioned near the top of nozzle 402 by drive mechanism 802 to be closer to wafer 100. As depicted in FIG. 8B, as stream of electrolyte 108 is applied closer to the edge of wafer 100, diffuser 402 is lowered within nozzle 402 by drive mechanism 802 to be farther away from wafer 100.

Drive mechanism 802 can include a motor, hydraulic piston, cylinder, and the like. Electrode 202 and diffuser 402 can be made of any metal, such as stainless steel, Titanium or Tantalum, Platinum, and the like. As depicted in FIG. 8A, nozzle 106 can include a nozzle body 804, which can be formed from any insulator, such as plastic, quartz, and the like.

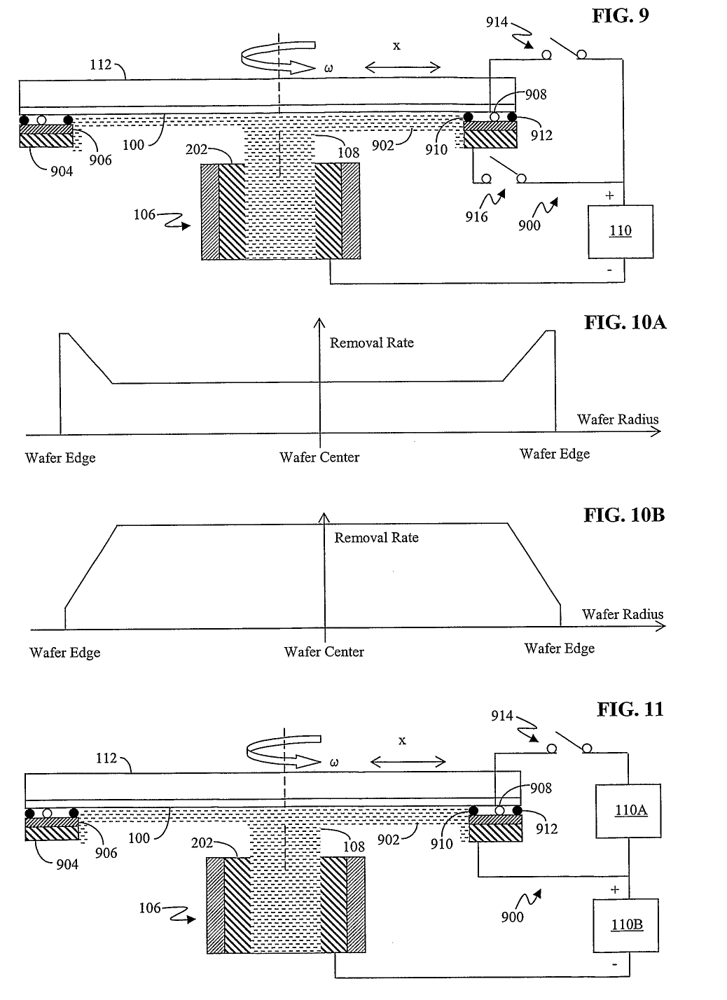

With reference to FIG. 9, during an electropolishing process, a portion of the metal layer at or near the edge of wafer 100 is typically polished faster (i.e., the removal rate is higher) than the portion of the metal layer on other areas of wafer 100, such as near the center of wafer 100. In particular, FIG. 1OA depicts removal rate from the center to the edge of a wafer. As depicted in FIG. 10A, the removal rate can increase sharply near the edge of the wafer as compared to the center of the wafer.

Thus, with reference again to FIG. 9, in one exemplary embodiment, dual electrodes are used to control removal rate uniformity near the edge of wafer 100. In particular, an electropolishing charge is applied to a first electrode 908 to apply an electropolishing charge to wafer 100, while an electropolishing charge is applied to second electrode 904 to draw a current from the electrolyte near the edge of wafer 100. For a more detailed description of using dual electrodes to control removal rate uniformity near the edge of the wafer, see U.S. Provisional Application Ser. No. 60/332,417, titled ELECTROPOLISHING ASSEMBLY, filed on Nov. 13, 2001; U.S. Provisional Application Ser. No. 60/372,567, entitled METHOD AND APPARATUS FOR ELECTROPOLISHING METAL FILM ON SUBSTRATE, filed on Apr. 14, 2002; and PCT Patent Application No. PCT/IUS02/36567, entitled ELECTROPOLISHING ASSEMBLY AND METHODS FOR ELECTROPOLISHING CONDUCTIVE LAYERS, filed on Nov. 13, 2002, which is now U.S. patent application Ser. No. 10/495,206, filed as a 371 application on May 10, 2004, all of which are incorporated herein by reference in their entirety.

In the present exemplary embodiment, in addition to using dual electrodes (i.e., first and second electrodes 908, 904), a control circuit 900 is used to adjust the electropolishing charges applied to first and second electrodes 908, 904 during the electropolishing process based on the radial location of stream of electrolyte 108 on wafer 100. In particular, when stream of electrolyte 108 is near the center of wafer 100, the electropolishing charge applied to second electrode 904 is greater than the electropolishing charge applied to first electrode 908. When stream of electrolyte 108 is near the edge of wafer 100, the electropolishing charge applied to second electrode 904 is less than the electropolishing charge applied to first electrode 908. Additionally, the electropolishing charge applied to first electrode 908 is greater when stream of electrolyte 108 is near the edge of wafer 100 than when stream of electrolyte 108 is near the center of wafer 100. Furthermore, the electropolishing charge applied to second electrode 904 is greater when stream of electrolyte 108 is near the center of wafer 100 than when stream of electrolyte 108 is near the edge of wafer 100. By adjusting the electropolishing charges applied to first and second electrodes 908, 904 in this manner, removal rate uniformity is enhanced across wafer 100, and, in particular, near the edge of wafer 100.

In the exemplary embodiment depicted in FIG. 9, control circuit 900 includes a first switch 914 connected between first electrode 908 and power supply 110. Control circuit 900 also includes a second switch 916 connected between second electrode 904 and power supply 110. In the present exemplary embodiment, first and second switches 914, 916 are opened (turned off) and closed (turned on) based on the radial location of stream of electrolyte 108 on wafer 100.

In particular, when stream of electrolyte 108 is near the center of wafer 100 and far from the edge of wafer 100, first switch 914 is opened and second switch 916 is closed. As depicted in FIG. 9, during the electropolishing process, electrolyte from stream of electrolyte 108 flows across wafer 100 toward the edge of wafer 100 and contacts second electrode 904. Thus, electropolishing current flows through the electrolyte and flows to second electrode 904 when reaching the edge of wafer 100, which enhances the removal rate, and thus can result in over-polishing, at the edge of wafer 100 (as depicted in FIG. 10A).

When stream of electrolyte 108 is near the edge of wafer 100, the electropolishing current is partially absorbed by second electrode 904. As depicted in FIG. 10B, the removal rate near the edge of wafer 100 can be reduced to a point where under-polishing can result.

Thus, with reference again to FIG. 9, in the present exemplary embodiment, control circuit 900 is operated in accordance with the following exemplary sequence to enhance removal rate uniformity near the edge of wafer 100:
1. When stream of electrolyte 108 is near the center of wafer 100 and far from the edge of wafer 100, close switch 916 and open switch 914. Thus, the electropolishing charge applied to second electrode 904 is greater than the electropolishing charge applied to first electrode 908, which is zero with switch 914 open.
2. When stream of electrolyte 108 is near the edge of wafer 100, open switch 916 and close switch 914. Thus, the electropolishing charge applied to second electrode 904 is less than the electropolishing charge applied to first electrode 908. Additionally, the electropolishing charge applied to first electrode 908 is greater when stream of electrolyte 108 is near the edge of wafer 100 than when stream of electrolyte 108 is near the center of wafer 100.

Furthermore, the electropolishing charge applied to second electrode 904 is greater when stream of electrolyte 108 is near the center of wafer 100 than when stream of electrolyte 108 is near the edge of wafer 100.
3. When stream of electrolyte 108 is over the edge of wafer 100, open switch 916 and open switch 914.

When stream of electrolyte 108 is applied from the center of wafer 100 toward the edge of wafer 100, the exemplary sequence set forth above can be performed in order from 1to 3. When stream of electrolyte 108 is applied from the edge of wafer 100 toward the center of wafer 100, the exemplary sequence set forth above can be performed in order from 3to 1.

Alternatively, control circuit 900 can be operated in accordance with the following exemplary sequence to enhance removal rate uniformity near the edge of wafer 100:

1. When stream of electrolyte 108 is near the center of wafer 100 and far from the edge of wafer 100, close switch 916 and open switch 914.
2. When stream of electrolyte 108 is near the edge of wafer 100, close switch 916 and close switch 914.
3. When stream of electrolyte 108 is at the edge of wafer 100, open switch 916 and close switch 914.
4. When stream of electrolyte 108 is over the edge of wafer 100, open switch 916 and open switch 914.

When stream of electrolyte 108 is applied from the center of wafer 100 toward the edge of wafer 100, the exemplary sequence set forth above can be performed in order from 1to 4. When stream of electrolyte 108 is applied from the edge of wafer 100 toward the center of wafer 100, the exemplary sequence set forth above can be performed in order from 4to 1.

In the present exemplary embodiment, the electropolishing current or voltage can be adjusted when stream of electrolyte 108 is near the edge of wafer 100 to further fine-tune, and thus enhance the uniformity of, the removal rate profile near the edge of wafer 100. The electropolishing current or voltage can be adjusted based on the removal rate profile measured near the edge of a previous wafer that was electropolished. If the removal rate near the edge of the previous wafer was high, then the electropolishing current or voltage is reduced when stream of electrolyte 108 is near the edge of the current wafer being electropolished. If the removal rate near the edge of the previous wafer was low, then the electropolishing current or voltage is enhanced when stream of electrolyte 108 is near the edge of the current wafer being electropolished. Note that the electropolishing current is adjusted when power supplies 110 operates in a constant current mode, and the electropolishing voltage is adjusted when power supply 110 operates in a constant voltage mode.

In the present exemplary embodiment, inner seal 910 and outer seal 912 isolate first electrode 908 from the electrolyte during the electropolishing process. An insulator 906 is disposed between first and second electrodes 908, 904 to electrically isolate first and second electrodes 908, 904. Inner and outer seals 910, 912 and insulator 906 can be formed from plastics (e.g., polyvinyl chloride, polyvinylidene fluoride, polytetrafluoroethylene, and the like), rubber (e.g., Viton, silicon rubber, and the like), or any other material that is electrically insulative and resistant to acid and corrosion. First and second electrodes 908, 904 can be formed from any metal, such as stainless steel, Titanium, Tantalum, Platinum, and the like. Inner and outer seals 910, 912 can be o-rings. First electrode 908 can be one or more coil springs disposed around the outer circumference of wafer chuck 112. Second electrode 904 can be a ring structure also disposed around the outer circumference of wafer chuck 112. For a more detailed description of an exemplary wafer chuck, see U.S. Pat. No. 6,248,222, entitled METHODS AND APPARATUS FOR HOLDING AND POSITIONING SEMICONDUCTOR WORKPIECES DURING ELECTROPOLISHING AND/OR ELECTROPLATING OF THE WORKPIECES, issued on Jun. 19, 2001, and U.S. Pat. No. 6,726,823, entitled METHODS AND APPARATUS FOR HOLDING AND POSITIONING SEMICONDUCTOR WORKPIECES DURING ELECTROPOLISHING AND/OR ELECTROPLATING OF THE WORKPIECES, issued on Apr. 27,2004, which are both incorporated herein by reference in their entireties.

With reference to FIG. 11, in another exemplary embodiment, a second power supply 110B is connected to second electrode 904, and a first power supply 110B is connected to switch 914, which is connected to first electrode 908. In the present exemplary embodiment, switch 916 (FIG. 9) has been omitted. First and second power supplies 110A, 110B can be operated in either constant current mode or constant voltage mode.

In the present exemplary embodiment, control circuit 900 is operated in accordance with the following exemplary sequence to enhance removal rate uniformity near the edge of wafer 100:

1. When stream of electrolyte 108 is near the center of wafer 100 and far from the edge of wafer 100, open switch 914 and apply electropolishing charge to second electrode 904 using second power supply 110B. Thus, the electropolishing charge applied to second electrode 904 is greater than the electropolishing charge applied to first electrode 908, which is zero with switch 914 open.
2. When stream of electrolyte 108 is near the edge of wafer 100, close switch 914 to apply electropolishing charge to first electrode 908 using first power supply 110A. Thus, the electropolishing charge applied to second electrode 904 is less than the electropolishing charge applied to first electrode 908. Additionally, the electropolishing charge applied to first electrode 908 is greater when stream of electrolyte 108 is near the edge of wafer 100 than when stream of electrolyte 108 is near the center of wafer 100. Furthermore, the electropolishing charge applied to second electrode 904 is greater when stream of electrolyte 108 is near the center of wafer 100 than when stream of electrolyte 108 is near the edge of wafer 100.
3. When stream of electrolyte 108 is over the edge of wafer 100, turn off first and second power supplies 110A, 110B.

When stream of electrolyte 108 is applied from the center of wafer 100 toward the edge of wafer 100, the exemplary sequence set forth above can be performed in order from 1to 3. When stream of electrolyte 108 is applied from the edge of wafer 100 toward the center of wafer 100, the exemplary sequence set forth above can be performed in order from 3to 1.

In the present exemplary embodiment, the electropolishing current or voltage can be adjusted when stream of electrolyte 108 is near the edge of wafer 100 to further fine-tune, and thus enhance the uniformity of, the removal rate profile near the edge of wafer 100. The electropolishing current or voltage can be adjusted based on the removal rate profile measured near the edge of a previous wafer that was electropolished. If the removal rate near the edge of the previous wafer was high, then the electropolishing current or voltage is reduced when stream of electrolyte 108 is near the edge of the current wafer being electropolished. If the removal rate near the edge of the previous wafer was low, then the electropolishing current or voltage is increased when stream of electrolyte 108 is near the edge of the current wafer being electropolished. Note that the electropolishing current is adjusted when first and second power supplies 110A, 110B operate in a constant current mode, and the electropolishing voltage is adjusted when first and second power supplies 110A, 110B operate in a constant voltage mode.

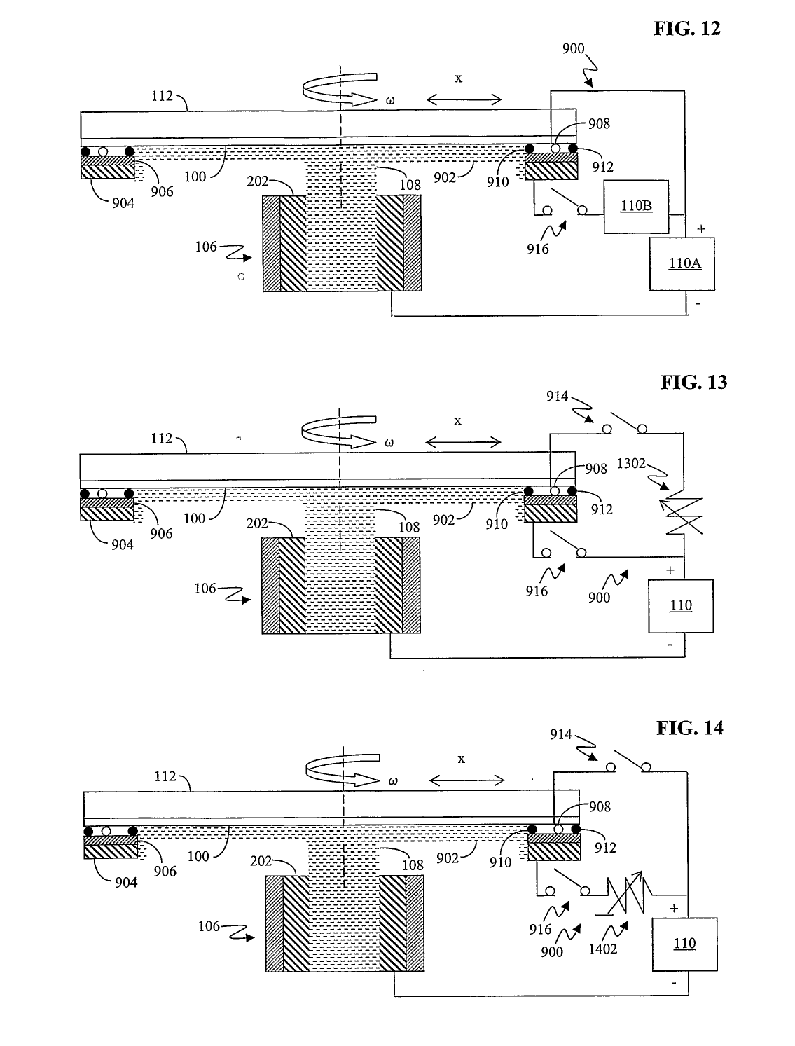

With reference to FIG. 12, in another exemplary embodiment, second power supply 110B is connected to second electrode 904 through switch 916, and first power supply 110B is connected to first electrode 908. In the present exemplary embodiment, switch 914 (FIG. 9) has been omitted. First and second power supplies 110A, 110B can be operated in either constant current mode or constant voltage mode.

In the present exemplary embodiment, control circuit 900 is operated in accordance with the following exemplary sequence to enhance removal rate uniformity near the edge of wafer 100:

1. When stream of electrolyte 108 is near the center of wafer 100 and far from the edge of wafer 100, close switch 916, apply electropolishing charge to second electrode 904 using second power supply 110B, and apply electropolishing charge to first electrode 908 using first power supply 110A, but apply more electropolishing charge to second electrode 904 using second power supply 110B than to first electrode 908 using first power supply 110A (e.g., set second power supply 110B so that majority of the electropolishing current flows through second electrode 904). Thus, the electropolishing charge applied to second electrode 904 is greater than the electropolishing charge applied to first electrode 908.

2. When stream of electrolyte 108 is near the edge of wafer 100, open switch 916 and apply electropolishing charge to first electrode 908 using first power supply 110A. Alternatively, rather than opening switch 916, the amount of electropolishing charge applied to second electrode 904 using second power supply 110B can be reduced so that a majority of the electropolishing current flows through first electrode 904. Thus, the electropolishing charge applied to second electrode 904 is less than the electropolishing charge applied to first electrode 908. Additionally, the electropolishing charge applied to first electrode 908 is greater when stream of electrolyte 108 is near the edge of wafer 100 than when stream of electrolyte 108 is near the center of wafer 100. Furthermore, the electropolishing charge applied to second electrode 904 is greater when stream of electrolyte 108 is near the center of wafer 100 than when stream of electrolyte 108 is near the edge of wafer 100.

3. When stream of electrolyte 108 is over the edge of wafer 100, turn off first and second power supplies 110A, 110B.

When stream of electrolyte 108 is applied from the center of wafer 100 toward the edge of wafer 100, the exemplary sequence set forth above can be performed in order from 1to 3. When stream of electrolyte 108 is applied from the edge of wafer 100 toward the center of wafer 100, the exemplary sequence set forth above can be performed in order from 3to 1.

In the present exemplary embodiment, the electropolishing current or voltage can be adjusted when stream of electrolyte 108 is near the edge of wafer 100 to further fine-tune, and thus enhance the uniformity of, the removal rate profile near the edge of wafer 100. The electropolishing current or voltage can be adjusted based on the removal rate profile measured near the edge of a previous wafer that was electropolished. If the removal rate near the edge of the previous wafer was high, then the electropolishing current or voltage is reduced when stream of electrolyte 108 is near the edge of the current wafer being electropolished. If the removal rate near the edge of the previous wafer was low, then the electropolishing current or voltage is increased when stream of electrolyte 108 is near the edge of the current wafer being electropolished. Note that the electropolishing current is adjusted when first and second power supplies 110A, 110B operate in a constant current mode, and the electropolishing voltage is adjusted when first and second power supplies 110, 110B operate in a constant voltage mode.

FIG. 13 depicts another exemplary embodiment. The present exemplary embodiment is similar to the exemplary embodiment depicted in FIG. 9, except for the addition of resistor 1302 between switch 914 and power supply 110. Resistor 1302 can be either a constant or adjustable resistor.

In the present exemplary embodiment, control circuit 900 is operated in accordance with the following exemplary sequence to enhance removal rate uniformity near the edge of wafer 100:
1. When stream of electrolyte 108 is near the center of wafer 100 and far from the edge of wafer 100, close switch 916 and open switch 914. Thus, the electropolishing charge applied to second electrode 904 is greater than the electropolishing charge applied to first electrode 908, which is zero with switch 914 open.
2. When stream of electrolyte 108 is near the edge of wafer 100, close switch 914 and set resistor 1302 so that a certain portion of the electropolishing current flows through first electrode 908. Thus, the electropolishing charge applied to second electrode 904 is less than the electropolishing charge applied to first electrode 908. Additionally, the electropolishing charge applied to first electrode 908 is greater when stream of electrolyte 108 is near the edge of wafer 100 than when stream of electrolyte 108 is near the center of wafer 100. Furthermore, the electropolishing charge applied to second electrode 904 is greater when stream of electrolyte 108 is near the center of wafer 100 than when stream of electrolyte 108 is near the edge of wafer 100.
3. When stream of electrolyte 108 is over the edge of wafer 100, open switch 916 and open switch 914.

When stream of electrolyte 108 is applied from the center of wafer 100 toward the edge of wafer 100, the exemplary sequence set forth above can be performed in order from 1to 3. When stream of electrolyte 108 is applied from the edge of wafer 100 toward the center of wafer 100, the exemplary sequence set forth above can be performed in order from 3to 1.

In the present exemplary embodiment, resistor 1302 can be set based on the removal rate profile measured near the edge of a previous wafer that was electropolished. If the removal rate near the edge of the previous wafer was high, then the resistance setting of resistor 1302 is increased to reduce the amount of the electropolishing current flowing through first electrode 908. If the removal rate near the edge of the previous wafer was low, then the resistance setting of resistor 1302 is decreased to increase the amount of the electropolishing current flowing through first electrode 908.

FIG. 14 depicts another exemplary embodiment. The present exemplary embodiment is similar to the exemplary embodiment depicted in FIG. 9, except for the addition of resistor 1402 between switch 916 and power supply 110. Resistor 1402 can be either a constant or adjustable resistor.

In the present exemplary embodiment, control circuit 900 is operated in accordance with the following exemplary sequence to enhance removal rate uniformity near the edge of wafer 100:
1. When stream of electrolyte 108 is near the center of wafer 100 and far from the edge of wafer 100, close switch 916 and open switch 914. Thus, the electropolishing charge applied to second electrode 904 is greater than the electropolishing charge applied to first electrode 908, which is zero with switch 914 open.
2. When stream of electrolyte 108 is near the edge of wafer 100, close switch 914 and set resistor 1402 so that a certain portion of the electropolishing current flows through first electrode 908. Thus, the electropolishing charge applied to second electrode 904 is less than the electropolishing charge applied to first electrode 908. Additionally, the electropolishing charge applied to first electrode 908 is greater when stream of electrolyte 108 is near the edge of wafer 100 than when stream of electrolyte 108 is near the center of wafer 100. Furthermore, the electropolishing charge applied to second electrode 904 is greater when stream of electrolyte 108 is near the center of wafer 100 than when stream of electrolyte 108 is near the edge of wafer 100.
3. When stream of electrolyte 108 is over the edge of wafer 100, open switch 916 and open switch 914.

When stream of electrolyte 108 is applied from the center of wafer 100 toward the edge of wafer 100, the exemplary sequence set forth above can be performed in order from 1to 3. When stream of electrolyte 108 is applied from the edge of wafer 100 toward the center of wafer 100, the exemplary sequence set forth above can be performed in order from 3to 1.

In the present exemplary embodiment, resistor 1302 can be set based on the removal rate profile measured near the edge of a previous wafer that was electropolished. If the removal rate near the edge of the previous wafer was high, then the resistance setting of resistor 1402 is reduced to reduce the amount of the electropolishing current flowing through first electrode 908. If the removal rate near the edge of the previous wafer was low, then the resistance setting of resistor 1402 is increased to increase the amount of the electropolishing current flowing through first electrode 908.

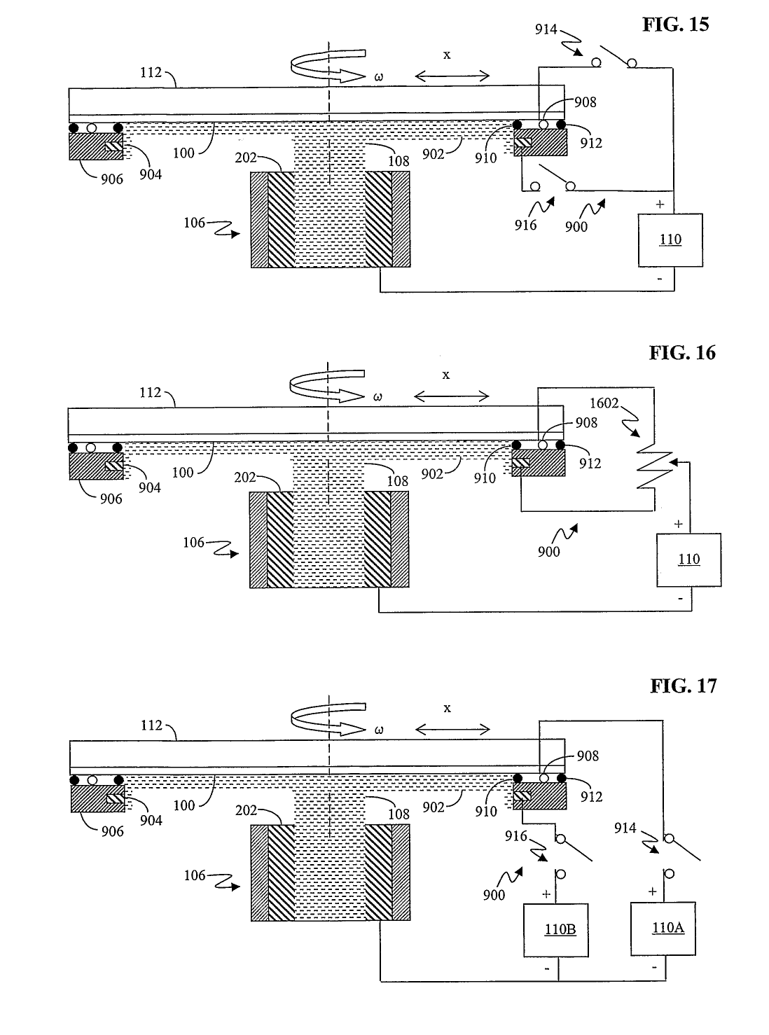

FIG. 15 depicts another exemplary embodiment. The present exemplary embodiment is similar to the exemplary embodiment depicted in FIG. 9, except that second electrode 904 is partially embedded in insulator 906. Control circuit 900 is operated in the same manner as described above for the exemplary embodiment depicted in FIG. 9.

FIG. 16 depicts another exemplary embodiment. The present exemplary embodiment is similar to the exemplary embodiment depicted in FIG. 15, except that first and second switches 914, 916 are replaced with a three-way resistor 1602, which is connected to first and second electrodes 908, 904 and power supply 110. Resistor 1602 can be either a constant or adjustable resistor.

In the present exemplary embodiment, control circuit 900 is operated in accordance with the following exemplary sequence to enhance removal rate uniformity near the edge of wafer 100:
1. When stream of electrolyte 108 is near the center of wafer 100 and far from the edge of wafer 100, set three-way resistor 1602 to make the resistance between second electrode 904 and power supply 110 to be a minimum value so that the majority of the electropolishing current flows through second electrode 904. Thus, the electropolishing charge applied to second electrode 904 is greater than the electropolishing charge applied to first electrode 908.
2. When stream of electrolyte 108 is near the edge of wafer 100, set three-way resistor 1602 by increasing the resistance between second electrode 904 and power supply 110 so that a certain portion of the electropolishing current flows through first electrode 908, which is greater than the amount of the electropolishing current that flowed through first electrode 908 when stream of electrolyte 108 is near the center of wafer 100. Thus, the electropolishing charge applied to second electrode 904 is less than the electropolishing charge applied to first electrode 908. Additionally, the electropolishing charge applied to first electrode 908 is greater when stream of electrolyte 108 is near the edge of wafer 100 than when stream of electrolyte 108 is near the center of wafer 100. Furthermore, the electropolishing charge applied to second electrode 904 is greater when stream of electrolyte 108 is near the center of wafer 100 than when stream of electrolyte 108 is near the edge of wafer 100.
3. When stream of electrolyte 108 is over the edge of wafer 100, turn off power supply 110.

When stream of electrolyte 108 is applied from the center of wafer 100 toward the edge of wafer 100, the exemplary sequence set forth above can be performed in order from 1to 3. When stream of electrolyte 108 is applied from the edge of wafer 100 toward the center of wafer 100, the exemplary sequence set forth above can be performed in order from 3to 1.

In the present exemplary embodiment, three-way resistor 1602 can be set based on the removal rate profile measured near the edge of a previous wafer that was electropolished. If the removal rate near the edge of the previous wafer was high, then the resistance setting of three-way resistor 1602 between first electrode 908 and power supply 110 is increased to reduce the amount of the electropolishing current flowing through first electrode 908. If the removal rate near the edge of the previous wafer was low, then the resistance setting of three-way resistor 1602 between first electrode 908 and power supply 11O is decreased to increase the amount of the electropolishing current flowing through first electrode 908.

FIG. 17 depicts another exemplary embodiment. The present exemplary embodiment is similar to the exemplary embodiment depicted in FIG. 15, except that a first power supply 110A is connected to switch 914, which is connected to first electrode 908, and a second power supply 110B is connected to switch 916, which is connected to second electrode 904.

In the present exemplary embodiment, control circuit 900 is operated in accordance with the following exemplary sequence to enhance removal rate uniformity near the edge of wafer 100:
1. When stream of electrolyte 108 is near the center of wafer 100 and far from the edge of wafer 100, close switch 916 and open switch 914. Thus, the electropolishing charge applied to second electrode 904 is greater than the electropolishing charge applied to first electrode 908, which is zero with switch 914 open.
2. When stream of electrolyte 108 is near the edge of wafer 100, close switch 914, and adjust the amount of electropolishing charge applied by first and second power supplies 110, 110B so that a certain amount of the electropolishing current flows through first electrode 908. Thus, the electropolishing charge applied to second electrode 904 is less than the electropolishing charge applied to first electrode 908. Additionally, the electropolishing charge applied to first electrode 908 is greater when stream of electrolyte 108 is near the edge of wafer 100 than when stream of electrolyte 108 is near the center of wafer 100. Furthermore, the electropolishing charge applied to second electrode 904 is greater when stream of electrolyte 108 is near the center of wafer 100 than when stream of electrolyte 108 is near the edge of wafer 100.
3. When stream of electrolyte 108 is over the edge of wafer 100, open switch 916 and open switch 914.

Alternatively, control circuit 900 can be operated in accordance with the following exemplary sequence to enhance removal rate uniformity near the edge of wafer 100:
1. When stream of electrolyte 108 is near the center of wafer 100 and far from the edge of wafer 100, close switch 916 and open switch 914. Thus, the electropolishing charge applied to second electrode 904 is greater than the electropolishing charge applied to first electrode 908, which is zero with switch 914 open.
2. When stream of electrolyte 108 is near the edge of wafer 100, open switch 916 and close switch 914. Thus, the electropolishing charge applied to second electrode 904 is less than the electropolishing charge applied to first electrode 908. Additionally, the electropolishing charge applied to first electrode 908 is greater when stream of electrolyte 108 is near the edge of wafer 100 than when stream of electrolyte 108 is near the center of wafer 100. Furthermore, the electropolishing charge applied to second electrode 904 is greater when stream of electrolyte 108 is near the center of wafer 100 than when stream of electrolyte 108 is near the edge of wafer 100. Note that the use of first and second power supplies 110, 110B allows for the electropolishing charge applied to first electrode 908 by first power supply 110, when stream of electrolyte 108 is near the edge of wafer 100, can differ from the electropolishing charge applied to second electrode 904 by second power supply 110B, when stream of electrolyte 108 is near the center of wafer 100.
3. When stream of electrolyte 108 is over the edge of wafer 100, open switch 916 and open switch 914.

When stream of electrolyte 108 is applied from the center of wafer 100 toward the edge of wafer 100, the exemplary sequence set forth above can be performed in order from 1to 3. When stream of electrolyte 108 is applied from the edge of wafer 100 toward the center of wafer 100, the exemplary sequence set forth above can be performed in order from 3to 1.

In the present exemplary embodiment, the electropolishing current or voltage can be adjusted when stream of electrolyte 108 is near the edge of wafer 100 to further fine-tune, and thus enhance the uniformity of, the removal rate profile near the edge of wafer 100. The electropolishing current or voltage can be adjusted based on the removal rate profile measured near the edge of a previous wafer that was electropolished. If the removal rate near the edge of the previous wafer was high, then the electropolishing current or voltage is reduced when stream of electrolyte 108 is near the edge of the current wafer being electropolished. For example, the electropolishing current or voltage applied by first power supply 110A to first electrode 908 can be reduced. If the removal rate near the edge of the previous wafer was low, then the electropolishing current or voltage is increased when stream of electrolyte 108 is near the edge of the current wafer being electropolished. For example, the electropolishing current or voltage applied by first power supply 110A to first electrode 908 can be increased. Note that the electropolishing current is adjusted when first and second power supplies 110, 110B operate in a constant current mode, and the electropolishing voltage is adjusted when first and second power supplies 110A, 110B operate in a constant voltage mode.

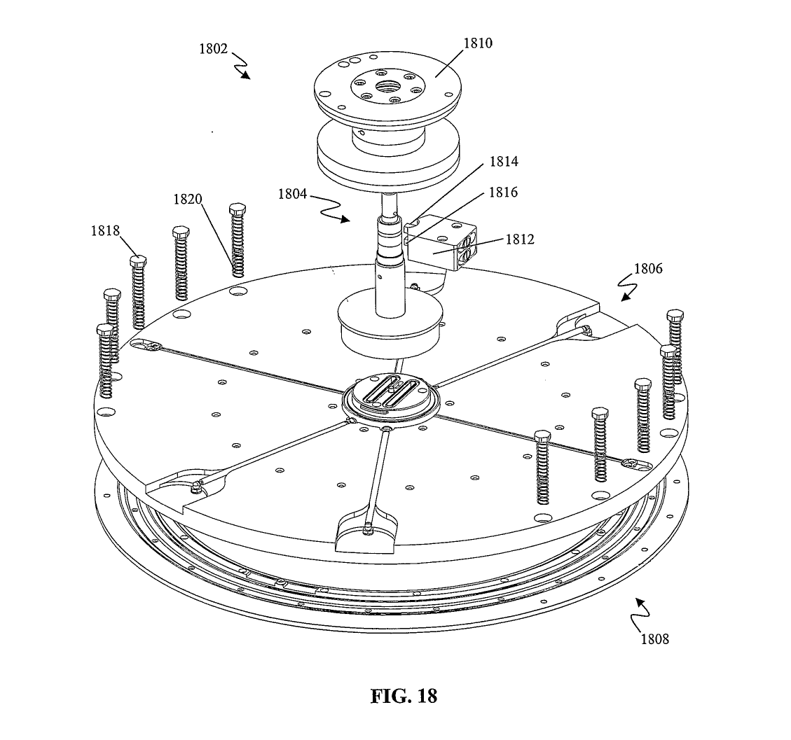

With reference to FIG. 18, an exemplary embodiment of a chuck assembly 1802 with dual electrodes is depicted. Chuck assembly 1802 is configured to hold and position a wafer during the electropolishing process. Additionally, in the present exemplary embodiment, chuck assembly 1802 is configured to provide electrical power through two different electrical paths as well as vacuum and gas (e.g., nitrogen, air, etc.).

As depicted in FIG. 18, chuck assembly 1802 includes a top assembly 1806, and a bottom assembly 1808. Top and bottom assemblies 1806, 1808 are connected together using two or more pins 1818 and compression springs 1820. Top and bottom assemblies 1806, 1808 can be opened to receive a wafer, and then closed to hold the wafer between top and bottom assemblies 1806, 1808, and seal the edges of the wafer during the electropolishing process.

In the present exemplary embodiment, top assembly 1806 is connected to shaft assembly 1804, which is connected to a rotary union 1810. Shaft assembly 1804 and rotary union 1810 facilitate the rotation of top and bottom assemblies 1806, 1808, and thus the wafer, during the electropolishing process. Shaft assembly 1804 and rotary union 1810 also provide vacuum and compressed gas to top and bottom assemblies 1806, 1808 while top and bottom assemblies 1806, 1808 are rotating. The vacuum can be used to hold and seal the wafer between the top and bottom assemblies 1806, 1808, while compressed gas can be used to assist in removing the wafer from between the top and bottom assemblies 1806, 1808 when the electropolishing process is completed.

Electrical contact assembly 1812 includes an upper contact 1814 and a lower contact 1816. Electrical contact assembly 1812 provides electrical power to top and bottom assemblies 1806, 1808 through two independent paths while top and bottom assemblies 1806, 1808 are rotating. In particular, electrical power is provided through a first electrical path using lower contact 1816, and through a second electrical path using upper contact 1814.

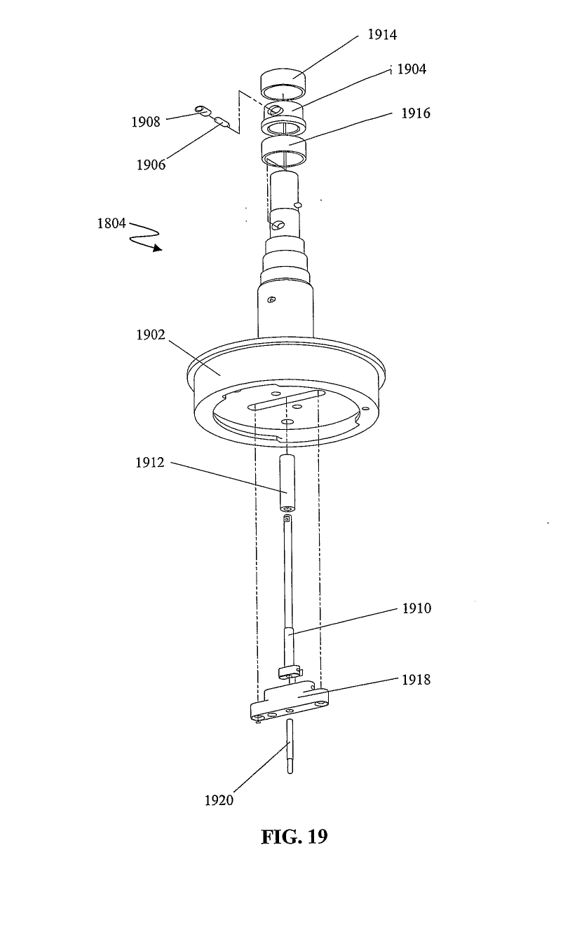

With reference to FIG. 19, shaft assembly 1804 is depicted in greater detail. Shaft assembly 1804 includes an upper contact ring 1914 and a lower contact ring 1916. Lower contact ring 1916 is electrically connected to a shaft 1902. Lower contact ring 1916 makes electrical contact with lower contact 1816 (FIG. 18) of electrical contact assembly 1812 (FIG. 18) to continue the first electrical path from lower contact 1816 (FIG. 18) to shaft 1902.

Upper contact ring 1914 is electrically connected to contact pin 1906, which is electrically connected to a contact rod 1910, which in turn is electrically connected to a spring contact 1920. Upper contact ring 1914 makes electrical contact with upper contact 1814 (FIG. 18) of electrical contact assembly 1812 (FIG. 18) to continue the second electrical path from upper contact 1814 (FIG. 18) to spring contact 1920.

As depicted in FIG. 19, shaft assembly 1804 includes a lower contact ring insulator 1904 to electrically isolate lower contact ring 1916 and upper contact ring 1914. Shaft assembly 1804 includes a contact pin insulator 1908 disposed on contact pin 1906. Shaft assembly 1804 also includes a contact rod holder 1918, which is connected to contact rod 1910 and spring contact 1920. A contact rod insulator 1912 is disposed on contact rod 1910.

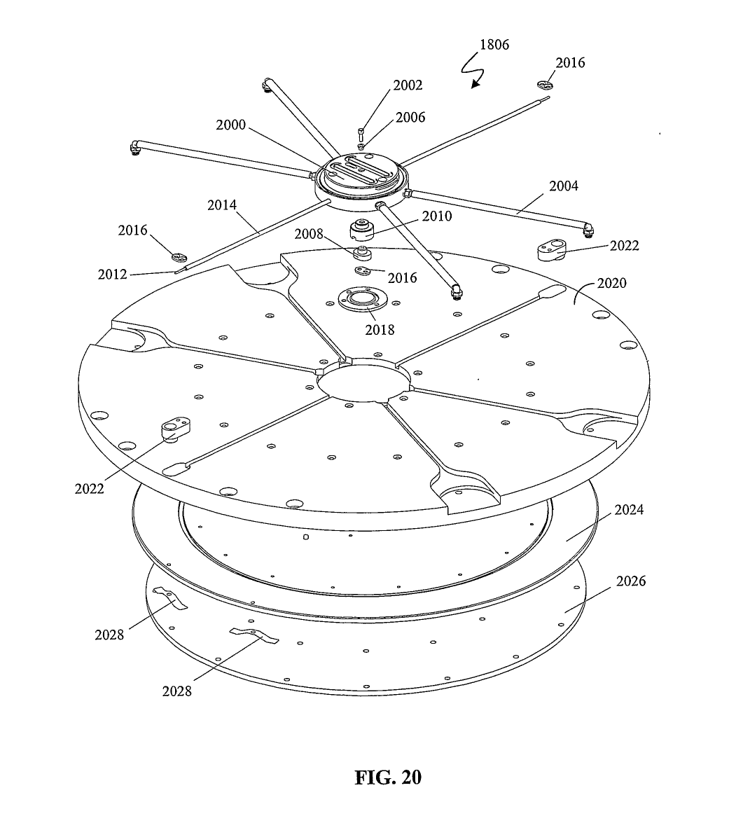

With reference to FIG. 20, top assembly 1806 is depicted in greater detail. Top assembly 1806 includes a block 2000, which is connected to two or more vacuum and gas channels 2004. Top assembly 1806 also includes a metal plate 2024 and leaf springs 2028. Block 2000 is electrically connected to metal plate 2024, which is electrically connected to leaf springs 2028. Block 2000 makes electrical contact with shaft 1902 (FIG. 19) of shaft assembly 1804 (FIG. 19) to continue the first electrical path from shaft 1902 (FIG. 19) to leaf springs 2028.

Top assembly 1806 includes a contact screw 2002, a contact nut 2008, wires 2012, and top plate inserts 2022. Contact screw 2002 is electrically connected to contact nut 2008, which is electrically connected to wires 2012, which are in turn electrically connected to top plate inserts 2022. Contact screw 2002 makes electrical contact with spring contact 1920 (FIG. 19) of shaft assembly 1804 (FIG. 19) to continue the second electrical path from spring contact 1920 (FIG. 19) to top plate inserts 2022.

As depicted in FIG. 20, top assembly 1806 includes a top plate 2020 and a bottom plate 2026. Top assembly 1806 includes a contact nut insulator 2010 disposed on contact nut 2008. Top assembly 1806 also includes a cover 2018 and clamps 2016. Contact screw insulator 2006 is disposed on contact screw 2002.

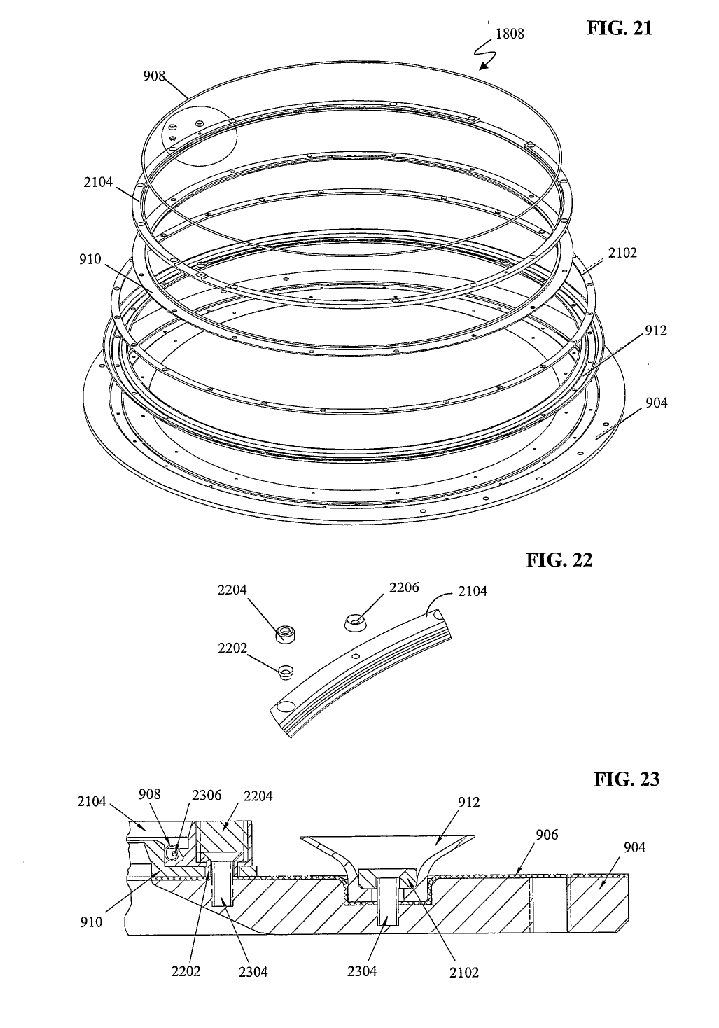

With reference to FIG. 21, bottom assembly 1808 is depicted in greater detail. Bottom assembly 1808 includes first electrode 908 and a wafer-centering ring 2104. Wafer-centering ring 2104 is electrically connected to first electrode 908. Wafer-centering ring 2104 makes electrical contact with leaf springs 2028 (FIG. 20) of top assembly 1806 (FIG. 20) to continue the first electrical path from leaf springs 2028 (FIG. 20) to first electrode 908.

Thus, the first electrical path includes lower contact 1816 (FIG. 18), lower contact ring 1916 (FIG. 19), shaft 1902 (FIG. 19), block 2000 (FIG. 20), metal plate 2024 (FIG. 20), leaf spring contacts 2028 (FIG. 20), wafer-centering ring 2104 (FIG. 21), and first electrode 908 (FIG. 21).

Bottom assembly 1808 includes second electrode 904. Second electrode 904 makes electrical contact with compression springs 1820 (FIG. 18) and pins 1818 (FIG. 18), which make electrical contact with top plate inserts 2022 (FIG. 20) in top assembly 1806 (FIG. 20) to continue the second electrical path from top plate inserts 2022 (FIG. 20) to second electrode 904.

Thus, the second electrical path includes upper contact 1814 (FIG. 18), upper contact ring 1814 (FIG. 19), contact pin 1906 (FIG. 19), contact rod 1910 (FIG. 19), spring contact 1920 (FIG. 19), contact screw 2002 (FIG. 20), contact nut 2008 (FIG. 20), wires 2012 (FIG. 20), top plate inserts 2022 (FIG. 20), compression springs 1820 (FIG. 18), pins 1818 (FIG. 18), and second electrode 904 (FIG. 21).

As depicted in FIG. 21, inner seal 910 tightens on to second electrode 904 with wafer-centering ring 2104. Outer seal 912 tightens on to second electrode 904 with clamp ring 2102. With reference to FIG. 22, screw insulator 2202 and plugs 2204 isolate centering ring 2104 from second electrode 904 (FIG. 21). Cones 2206 assist in guiding the wafer to land on wafer-centering ring 2104 when the wafer is being loaded into chuck assembly 1802 (FIG. 18).

As depicted in FIG. 23, insulator 906 is disposed on second electrode 904. Screws 2304 secure inner and outer seals 910, 912 to second electrode 904. Also, as described above, first electrode 908 can be one or more coil springs. Thus, as depicted in FIG. 23, a spring wire 2306 can be used to keep first electrode 908 in place.

Although various exemplary embodiments have been described, it will be appreciated that various modifications and alterations may be made by those skilled in the art. For example, the various concepts described above can be used with an electropolishing device that uses an applicator that directly contacts the metal layer rather than a nozzle that directs a stream of electrolyte without directly contacting the metal layer.

1. A method of controlling removal rate uniformity during an electropolishing process in integrated circuit fabrication on a wafer, the method comprising:
applying a stream of electrolyte to the wafer using a nozzle positioned adjacent to the wafer with a gap between the nozzle and the wafer; and
adjusting the gap between the nozzle and the wafer to adjust the removal rate profile of the stream of electrolyte applied by the nozzle.

2. The method of claim 1, wherein, when the gap is less than a diameter of the stream of electrolyte, the removal rate profile of the stream of electrolyte has a concave shape; and wherein, when the gap is greater than the diameter of the stream of electrolyte, the removal rate profile of the stream of electrolyte has a convex shape.

3. The method of claim 1, wherein the stream of electrolyte is applied to different radial locations on the wafer, and wherein the gap between the nozzle and the wafer is adjusted based on the radial location of the stream of electrolyte on the wafer.

4. The method of claim 3, wherein the gap is greater when the stream of electrolyte is applied to a radial location closer to the edge of the wafer than when the stream of electrolyte is applied to a radial location closer to the center of the wafer.

5. The method of claim 1, wherein the stream of electrolyte is applied from the center of the wafer toward the edge of the wafer, and wherein the gap between the nozzle and the wafer is increased as the stream of electrolyte is applied from the center of the wafer toward the edge of the wafer.

6. The method of claim 1, wherein the stream of electrolyte is applied from the edge of the wafer toward the center of the wafer, and wherein the gap between the nozzle and the wafer is decreased as the stream of electrolyte is applied from the edge of the wafer toward the center of the wafer.

7. A system for controlling removal rate uniformity during an electropolishing process in integrated circuit fabrication on a wafer, the system comprising:
a wafer chuck configured to hold the wafer during the electropolishing process; and
a nozzle configured to apply a stream of electrolyte to the wafer held by the wafer chuck, wherein the nozzle is positioned adjacent to the wafer with a gap between the nozzle and the wafer,
wherein the gap between the nozzle and the wafer is adjusted to adjust the removal rate profile of the stream of electrolyte applied by the nozzle.

8-44. (canceled)

45. The system of claim 7, wherein the wafer chuck is configured to move up and down to adjust the gap between the nozzle and the wafer, wherein the gap is greater when the nozzle is adjacent to the edge of the wafer than when the nozzle is adjacent to the center of the wafer.

46. The system of claim 45, wherein the wafer chuck is configured to translate from a first position to a second position, wherein in the first position the nozzle is adjacent to the center of the wafer, wherein in the second position the nozzle is adjacent to the edge of the wafer, and wherein wafer chuck is configured to move up to increase the gap as the wafer chuck translates from the first position to the second position.

47. The system of claim 46, further comprising:
a guide rod, wherein the wafer chuck is configured to translate on the guide rod; and
a motor connected to the wafer chuck, wherein the motor is configured to rotate the wafer chuck.

48. The system of claim 45, wherein the wafer chuck is configured to translate from a first position to a second position, wherein in the first position the nozzle is adjacent to the edge of the wafer, wherein in the second position the nozzle is adjacent to the center of the wafer, and wherein wafer chuck is configured to move down to decrease the gap as the wafer chuck translates from the first position to the second position.

49. The system of claim 48, further comprising:
a guide rod, wherein the wafer chuck is configured to translate on the guide rod; and
a motor connected to the wafer chuck, wherein the motor is configured to rotate the wafer chuck.

50. The system of claim 7, wherein the nozzle is configured to move up and down to adjust the gap between the nozzle and the wafer, wherein the gap is greater when the nozzle is adjacent to the edge of the wafer than when the nozzle is adjacent to the center of the wafer.

51. The system of claim 50, wherein the wafer chuck is configured to translate from a first position to a second position, wherein in the first position the nozzle is adjacent to the center of the wafer, wherein in the second position the nozzle is adjacent to the edge of the wafer, and wherein nozzle is configured to move down to increase the gap as the wafer chuck translates from the first position to the second position.

52. The system of claim 51, further comprising:
a guide rod, wherein the wafer chuck is configured to translate on the guide rod; and
a motor connected to the wafer chuck, wherein the motor is configured to rotate the wafer chuck.

53. The system of claim 50, wherein the wafer chuck is configured to translate from a first position to a second position, wherein in the first position the nozzle is adjacent to the edge of the wafer, wherein in the second position the nozzle is adjacent to the center of the wafer, and wherein nozzle is configured to move up to decrease the gap as the wafer chuck translates from the first position to the second position.

54. The system of claim 53, further comprising:
a guide rod, wherein the wafer chuck is configured to translate on the guide rod; and
a motor connected to the wafer chuck, wherein the motor is configured to rotate the wafer chuck.

55. A system for controlling removal rate uniformity during an electropolishing process in integrated circuit fabrication on a wafer, the system comprising:
a wafer chuck configured to hold the wafer during the electropolishing process; and
a nozzle configured to apply a stream of electrolyte to the wafer held by the wafer chuck, wherein the nozzle is positioned adjacent to the wafer with a gap between the nozzle and the wafer,
wherein the wafer chuck is configured to move up and down to adjust the gap between the nozzle and the wafer to adjust the removal rate profile of the stream of electrolyte applied by the nozzle, wherein the gap is greater when the nozzle is adjacent to the edge of the wafer than when the nozzle is adjacent to the center of the wafer.

56. The system of claim 55, wherein the wafer chuck is configured to translate from a first position to a second position, wherein in the first position the nozzle is adjacent to the center of the wafer, wherein in the second position the nozzle is adjacent to the edge of the wafer, and wherein nozzle is configured to move down to increase the gap as the wafer chuck translates from the first position to the second position.

57. The system of claim 56, further comprising:
a guide rod, wherein the wafer chuck is configured to translate on the guide rod; and
a motor connected to the wafer chuck, wherein the motor is configured to rotate the wafer chuck.
